(19) United States
(12) Patent Application Publication
(10) Pub. No.: US 2008/0229257 A1
(43) Pub. Date: Sep. 18, 2008

(54) SYSTEM AND METHOD FOR PRESENTING SCREENSAVERS

(75) Inventor: SCOTT WHITE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/686,281

(22) Filed: Mar. 14, 2007

(51) Int. Cl. G06F 3/048

(52) U.S. Cl. 715/867

(57) ABSTRACT

A system and method for presenting screensavers is disclosed. An apparatus that incorporates teachings of the present disclosure may include, for example, a set-top box having a controller element that presents at a media device one or more screensavers contextually associated with a paused media program. Additional embodiments are disclosed.

### FIELD OF THE DISCLOSURE

The present disclosure relates generally to screensavers, and more specifically to a system and method for presenting screensavers.

### BACKGROUND

Computer and television screens are susceptible to a problem called “burn-in.” Burn-in results from a static image being presented on-screen for too long, which can cause a portion of the static image to remain for an extended period of time on the screen. Set-top boxes (STB) and Digital Video Recorders (DVRs) have raised the risk of burn-in on consumer TV sets by enabling the user to pause TV programming and thereby allow a static image to remain on-screen.

Some manufacturers have responded by enabling screensavers, which replace the static image with an image in motion. However, to date many of these screensavers have consisted of simple images such as a provider or manufacturer logo in motion, which may not provide useful or relevant information to a user.

A need therefore arises for a system and method for presenting screensavers.

### BRIEF DESCRIPTION OF THE DRAWINGS

FIG. 1 depicts an exemplary embodiment of a system for presenting contextually associated screensavers;

FIG. 2 depicts an exemplary method operating in portions of the system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and method for presenting screensavers.

In a first embodiment of the present disclosure, a computing device in a communication system can have a controller element that detects an event associated with pausing presentation of a media program, identifies metadata associated with the paused media program, and selects a screensaver contextually associated with the paused media program according to said metadata.

In a second embodiment of the present disclosure, a method can involve displaying one or more screensavers contextually associated with a paused media program.

In a third embodiment of the present disclosure, a set-top box (STB) can have a controller element that presents at a media device one or more screensavers contextually associated with a paused media program.

In a fourth embodiment of the present disclosure, a media device can have a controller element that presents a media program, and presents one or more screensavers contextually associated with the media program after it has been paused.

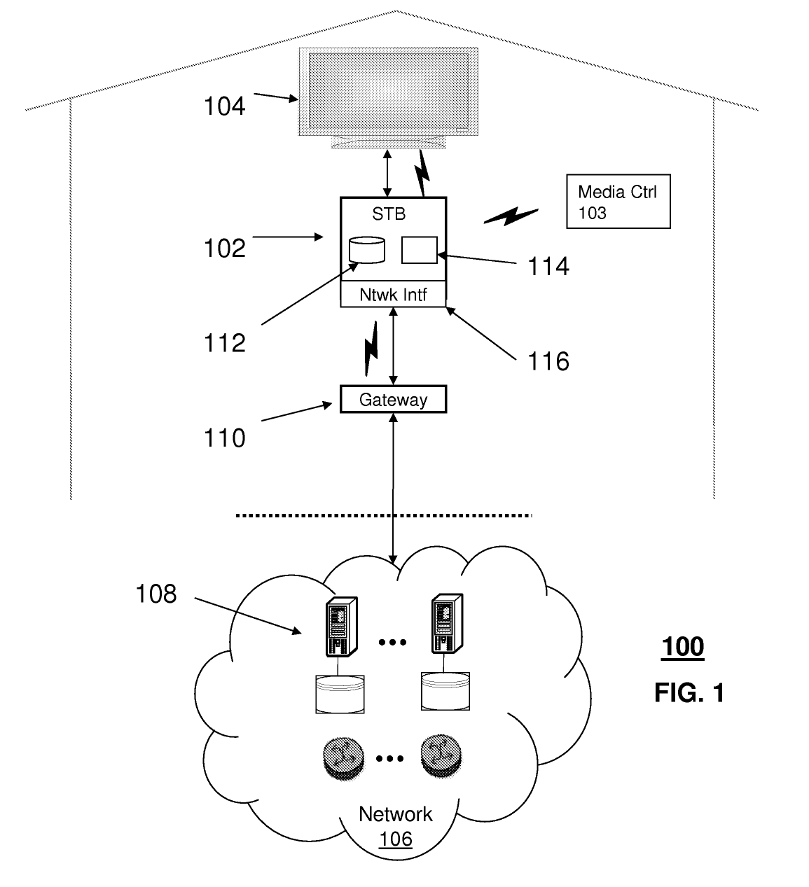

FIG. 1 depicts an exemplary embodiment of a system 100 for presenting contextually associated screensavers. Such screensavers can include textual, pictorial or visual still or moving images, and/or audio content. The system 100 can comprise an STB 102 managed by a common infrared or RF media controller 103 that can present media programs to a user on a media device 104. For example, in the system 100, the STB 102 can be a digital video recorder (DVR), a DVD player, a cable converter box, a satellite receiver, or any other apparatus that can output media programs to a media device 104, such as a television or computer screen.

The STB 102 can be configured to exchange information with one or more remote servers 108 of a media network 106 through a gateway device 110 (such as a common residential gateway). Remote servers 108 can operate as single computing systems or as centralized or decentralized computing devices. The remote servers 108 can be used to store information associated with media programs, such as programming information, and/or can be used to provide media programs for the STB 102 to display on the media device 104.

For example, a media network 106 can comprise a typical Internet Protocol TV (IPTV) backbone, where there is at least one remote server 108 comprising a super head office server (SHS) which receives national media programs from satellite and/or media servers from service providers of multimedia broadcast channels. The SHS server forwards IP packets associated with the media content to another remote server 108 such as a video head server (VHS) via a network of video head offices (VHO) according to a common multicast communication method. The VHS then distributes multimedia broadcast programs to commercial and/or residential buildings via gateway devices 110 that distribute broadcast signals to receivers such as STBs 102 which in turn present broadcast selections to media devices 104 such as fidelity audio systems, computers or television units managed in some instances by a media controller (e.g., an infrared or RF remote control). For illustration purposes only, the media device 104 is presented as a television unit in FIG. 1. Unicast traffic can also be exchanged between the STBs 102 and the remote servers 108 of the network 106 for services such as video-on-demand (VoD).

An STB 102 operating in the system 100 can comprise a mass storage system 112, a controller element 114, and a network interface 116. The mass storage system 112 can utilize common storage technologies (e.g., hard disk drives, flash memory, etc.) to store one or more media programs in one or more databases managed by the controller element 114. The controller element 114 can utilize common video processing technologies (e.g., MPEG 3 or 4, H.264, high definition TV, standard definition TV, etc.) to present and manage programs on the media device 104. The network interface 116 can utilize common networking technologies (e.g., LAN, WLAN, TCP/IP, etc.) to manage communication with the gateway 110 and the network 106 via wireline (e.g., Ethernet, or cable) or wireless communications (e.g., WiFi).

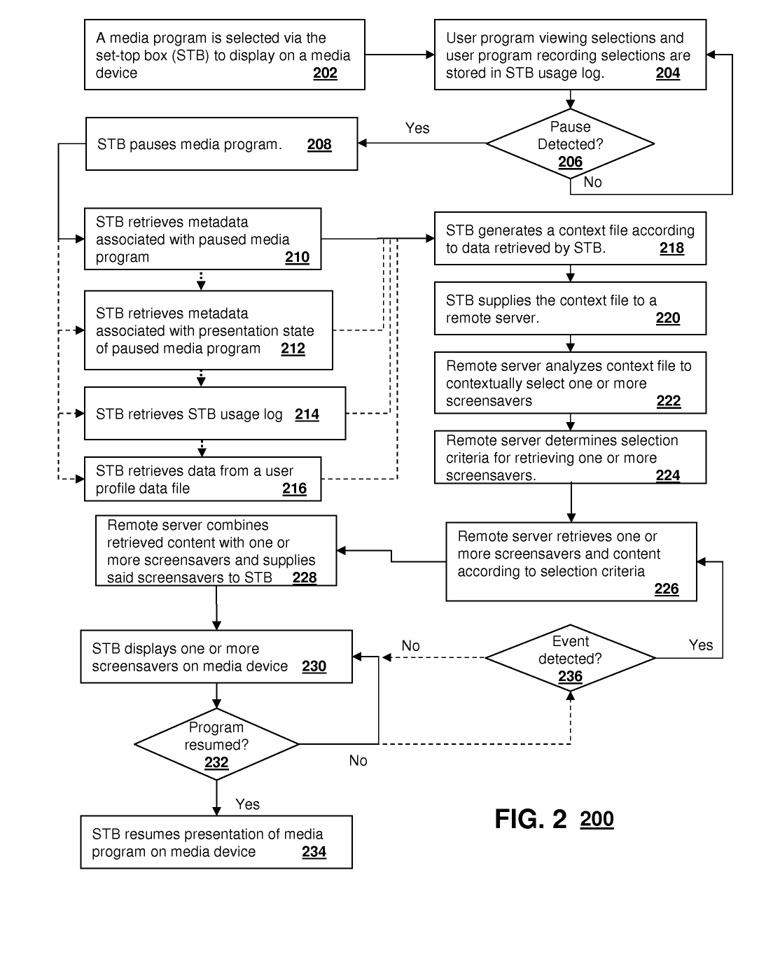

FIG. 2 depicts an exemplary method 200 operating in portions of the system 100. Method 200 begins with step 202 in which a user of the STB 102 selects and begins a visual presentation of a media program on a media device 104. Media programs can include any type of multimedia presentation including audio, visual, or audio/visual presentations. For example, the media program selected can comprise an audio-only program such as music, a visual-only program such as a video bulletin board or still pictures from a picture album, or an audio/visual program such as a movie or television program.

In response to the user selecting a media program, the STB 102 can collect the user selection in an STB usage log in step 204. A number of selections can be collected in the STB usage log which can vary in context. For example, in a STB 102 comprising a satellite receiver or a cable converter, information about each media program selected can be stored in the STB usage log. In another example, an STB 102 can comprise a DVR function that can be configured to store information about each media program selected by the user for recording purposes.

Although the STB 102 can store all user selections, the STB can be configured to selectively store pertinent user selections in the STB usage log. For instance, the STB 102 can be configured to store in the STB usage log channel selections having a minimum duration of consistent usage such as 10 minutes. Such a configuration can help to log channel selections watched with interest by the user rather than logging channel navigation activities associated with an end user's attempt to scan for a program of interest. Similarly, the STB 102 can also be configured to store in the STB usage log only media programs selected and recorded on a regular basis, such as a television series. Alternatively, the STB 102 can be programmed to store in the STB usage log selections of recorded media programs actually watched by the user rather than the entire collection of recorded media programs.

Along with the user selections, additional information can be stored in the STB usage log. For example, in a satellite receiver or a cable converter, the STB 102 can store metadata associated with the media program (e.g., channel number, channel description, program title, program description, etc.). An STB 102 can be configured to retrieve this metadata from an electronic program guide (EPG) of an interactive TV (iTV) subsystem, from a database in a remote server 108, or from metadata accompanying the media program. For example, the STB 102 can be configured to retrieve current and recorded media program metadata from the EPG of a satellite receiver or a cable converter. In situations where the media program is supplied in a DVD, a CD, or from a video on demand (VoD) service, metadata may be embedded within the media program itself. Thus, the STB 102 can retrieve both metadata located on remote servers 108 and metadata embedded in the media program.

The metadata associated with a media program can comprise simple or comprehensive information. For example, the metadata associated with a movie or television program can comprise identifying information such as the title of the media program, or more comprehensive data such as actor information, director or producer information, year of production, duration of program, available chapter and scene selections, etc.

Metadata can also be associated with indexed media programs. Indexed metadata can provide a presentation state of the indexed media program when paused. The presentation state can include a departure mark that identifies when the media program was paused. The presentation state can also include information associated with the state of programming at the paused point. For example, in a movie or television program, the metadata regarding actors in the media program can vary as different actors are presented in scenes of the media program. Similarly, for a media program such as a music video, a concert, or other musical performance, the metadata can vary according to the song being presented. Metadata for indexed media programs can be retrieved from a database stored on the remote server 108 or from metadata embedded within the media program.

Metadata can also include information indirectly related to the media program. For example, metadata can comprise information associated with products presented in the media program, identification of related or similar media programs, broadcast network information, etc.

From the foregoing embodiments, it would be evident to an artisan of ordinary skill in the art that metadata associated with a media program can be supplied by any entity including the media program itself, and can include any form or type of informative data relating to the media program.

Referring back to FIG. 2, once the STB 102 has stored one or more of the aforementioned embodiments of the STB usage log in step 204, the STB proceeds to step 206 where it monitors for a signal to pause the media program while it is being presented on the media device 104. The signal can result from a user depressing a pause button on the STB 102 or a pause button on the media controller 103. If the STB 102 detects no signal to pause the media program in step 206, the STB returns to step 204 where it stores selections in the STB usage log as described earlier. Once the STB 102 detects a pause signal in step 206, it pauses the media program in step 208.

In steps 210-218, the STB 102 can provide context-sensitive information to the remote server 108 that can be utilized to select one or more screensavers. In particular, the context-sensitive information can be supplied in the form of a context file. In step 210, for example, the STB 102 can be configured to retrieve metadata associated the paused media program. The metadata can be a single type of identifying information (e.g., program title), or comprehensive (e.g., title of the movie, production information, cast and crew, program duration, etc.).

Alternatively, or in combination with step 210, the STB 102 can be configured in step 212 to retrieve metadata associated with the presentation state of the paused media program based on indexed metadata, as previously discussed. For example, the retrieved metadata can include a departure mark identifying the paused scene, and the actors or products included in said scene. Similarly, for a musical program such as a concert, the retrieved metadata can include identifying information for the current musical number such as the title of a song, the singer, or the composer.

Alternatively, or in combination with at least one of steps 210-212, the STB 102 can be configured in step 214 to retrieve data stored in the STB usage log. As noted earlier, the STB usage log can provide active program selections and recorded selections collected by the STB 102. This information can be analyzed by the remote server 108 to determine use patterns of the STB 102.

Alternatively, or in combination with at least one of steps 210-214, the STB 102 can also be configured in step 216 to retrieve additional information unrelated to the media program. Such information can include a user profile stored in the STB 102 or retrieved from the media network 106. The user profile can represent a geographic location of the user, network programming subscriptions (e.g., internet service, phone service, etc.), and user preferences for screensavers and content. To establish the user preferences, the STB 102 can be configured to provide a user interface for selecting screensaver context preferences (e.g., news items, music, weather reports, a preference for pictorial content over textual content, location of content and so on). For example, the user profile can include a user preference to present musical content during the screensaver. The user profile can also include a location of such musical content (e.g., streaming internet radio, local device or network music playback, satellite or broadcast radio, and so on).

In step 218, the STB 102 generates the context file from context data supplied in at least one of steps 210-216. The context file can be generated in any format that can be recognized and used by a remote server 108 (such as the format used in relational database files, delimited text files, etc.). In step 220, the STB 102 supplies the generated context file to the remote server 108 of the network 106 for processing. The remote server 108 in turn analyzes in step 222 the context file to generate in step 224 selection criteria for retrieving content for the screens aver.

The remote server 108 can be configured to process the context file for specific types of metadata (e.g., media program titles, actors, singers, etc) to determine which data to use in generating the selection criteria. The remote server 108 can also perform statistical analysis of the STB usage log data to determine STB 102 use patterns and generate selection criteria for screensaver content based on metadata associated with the media programs more commonly selected or recorded. From the statistical analysis, demographic and/or psychographic can also be established as part of the selection criteria. The remote server 108 can also be configured to retrieve other information specified in a user profile that defines preferences for selecting content for the screensaver.

Based on the selection criteria, the remote server 108 can in step 226 retrieve one or more screensavers and content to combine therewith. Retrieved screensaver and content can include advertisements, informative trivia about the media program, suggestions for viewing other media programs of genre to the one being paused, and so forth. In sum, screensavers and the content supplied therewith can be tailored contextually to any informative aspect of the paused program, the use pattern of the STB 102 as detected from an STB usage log, a presentation state of the paused program, and/or a user profile—just to name a few.

Once the one or more screensavers and their respective content has been retrieved and combined in steps 226-228 by the remote server 108, it is delivered to the STB in step 228. The STB 102 in turn visually presents in step 230 the one or more screensavers on media device 104 by common means. Along with presenting the retrieved content for the screensaver, the STB 102 can also be configured to present STB status information. For example, a STB 102 can be configured to alert a user regarding VoD and/or DVR recording activities (e.g., your movie download is complete; recording of 24 begun; etc.). Such alerts can include a listing recordings currently in progress, a listing upcoming recordings, or a warning that recording space is low.

In step 232, the STB 102 can monitor user input signaling a request to resume presentation of the media program from its paused state. The user input signal can comprise a general signal, such as any user input, or a specific signal, such as a specific signal from a media controller 103 on the interface of the media device 104 or the STB 102. If a resumption request signal is detected in step 232, the presentation of the one or more context-sensitive screensavers is terminated and the STB 102 resumes in step 234 presentation of the media program at the media device 104 from its departure mark. However, if the STB 102 does not detect a resumption request, the STB continues displaying the one or more screensavers in step 230.

To provide a dynamic aspect to the content presented by the one or more screensavers, the STB 102 can be configured in step 236 to monitor for an event that triggers a change in the screensaver content. An event can be, for example, a timer that triggers every few minutes. Another event can be detection of a user selection in a user interface included in the screensaver. Such an interface can be configured to allow the user to select additional content to retrieve without exiting the screensaver. For example, when music from a playlist on a local device is being presented in the screensaver, controls (e.g., skip, fast forward, pause, selecting from a drop-down menu of songs in the playlist) can be provided that allow the user to navigate the playlist. In another example, when movie information is included in a screensaver when the movie is paused, the user interface can include controls to allow the user to select additional information to retrieve, such as actor information or soundtrack information.

In yet another example, an end user can be listening to streaming Internet radio while the screensaver is deployed. The screensaver can contain data about the current song (song title, album art, etc.). If the end user does not like the current song, the screensaver can provide a user interface with controls such as, for example, a ‘skip’ button to jump to the next song and can do so without suppressing the screensaver. When the user wants to get rid of the screensaver, an OK button or something similar presented by the screensaver can be selected to go back to a main application (e.g., playlist bar, selection of other radio stations, or playlist from a CD, etc.), while maintaining the integrity of the screensaver. Hence, the screensaver can be supplemented with graphical user interface (GUI) selectable elements to interactively manage operations of a media program without suppressing the screensaver itself.

When an event is detected in step 236, the STB 102 can be configured to restart the selection process in steps 226-228 as described earlier with the exception that the screensavers selected must differ from the previous ones submitted to the STB 102. Alternatively, or in combination with the foregoing embodiment, an event can be triggered from changes made to the STB usage log such as the start of a new DVR recording. In this embodiment, the STB 102 can be configured to generate and supply a new context file to the remote server 108 according to steps 210-220, which prompts the remote server 108 to generate one or more new screensavers according to steps 222-228. Once the one or more new screensavers have been supplied to the STB 102, the STB repeats the cycle of steps 230-232 until a new event is detected or a signal is detected in step 232 to resume presentation of the media program.

Upon reviewing the aforementioned embodiments, it would be evident to an artisan with ordinary skill in the art that said embodiments can be modified, reduced, or enhanced without departing from the scope and spirit of the claims described below. For example, the aforementioned steps in whole or in part can operate from the STB 102 or the media device 104. That is, the STB 102 or the media device 102 singly or in combination can be programmed to select the screensavers from its database based on the analysis steps previously described for the remote server 108. In yet another example, the STB 102 and the remote server 108 can frequently exchange metadata during an on-going media program presentation in order to accelerate presentation of the screensaver after a media program has been paused by caching screensavers at the STB. In yet another embodiment the media controller 103, media device 104, STB 102, and remote server 108 can in whole or in part be integrated to perform the methods described herein.

These are but a few examples of modifications that can be applied to the present disclosure without departing from the scope of the claims stated below. Accordingly, the reader is directed to the claims section for a fuller understanding of the breadth and scope of the present disclosure.

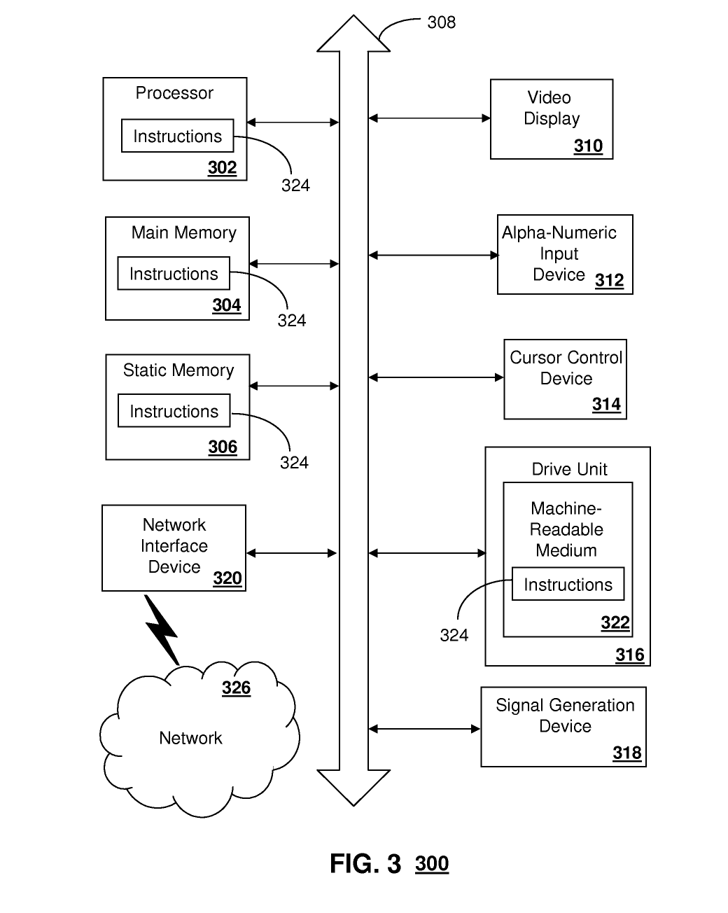

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computing device in a communication system, comprising a controller element that:
detects an event associated with pausing presentation of a media program;
identifies metadata associated with the paused media program; and
selects a screensaver contextually associated with the paused media program according to said metadata.

2. The computing device of claim 1, wherein the controller element further selects the screensaver according to an analysis of a set-top box (STB) usage log supplied to the computing device by an STB.

3. The computing device of claim 2, wherein the STB usage log comprises metadata associated with media program viewing selections collected by the STB.

4. The computing device of claim 2, wherein the STB usage log comprises metadata associated with media program recording selections collected by the STB.

5. The computing device of claim 1, wherein the controller element contextually adapts content presented by the selected screensaver according to a usage pattern supplied by an STB.

6. The computing device of claim 1, wherein the computing device corresponds to one or more remote servers comprising at least one among one or more Internet Protocol Television (IPTV) subsystems, an STB, a media device and a media controller that manages operations of the media device.

7. A method, comprising displaying one or more screensavers contextually associated with a paused media program.

8. The method of claim 7, comprising generating the one or more screensavers according to metadata associated with the paused media program, and wherein the metadata identifies a presentation state of the paused multimedia program.

9. The method of claim 7, comprising generating the one or more screensavers according to a user profile.

10. The method of claim 7, comprising generating the one or more screensavers according to a usage log identifying a collection of program viewing selections.

11. The method of claim 7, comprising generating the one or more screensavers according to a usage log identifying a collection of program recording selections.

12. The method of claim 7, comprising generating the one or more screensavers according to at least one among a collection of demographic information and psychographic information.

13. A set-top box (STB), comprising a controller element that presents at a media device one or more screensavers contextually associated with a paused media program.

14. The STB of claim 13, wherein the controller element selects the one or more screensavers according to metadata associated with the paused media program.

15. The STB of claim 14, wherein the metadata identifies a presentation state of the paused media program.

16. The STB of claim 13, wherein the controller element selects the one or more screensavers according to a user profile.

17. The STB of claim 13, wherein the controller element selects the one or more screensavers according to a collection of program viewing selections collected by the controller element.

18. The STB of claim 13, wherein the controller element selects the one or more screensavers according to a collection of program recording selections collected by the controller element.

19. The STB of claim 13, wherein the controller element selects the one or more screensavers according to at least one among demographic information and psychographic information collected by the controller element.

20. The STB of claim 13, wherein the controller element contextually adapts content presented by the selected screensaver in response to a trigger event detected by the controller element.

21. A media device, comprising a controller element that:
presents a media program; and
presents one or more screensavers contextually associated with the media program after it has been paused.

22. The media device of claim 21, wherein the one or more screensavers are selected by a system according to metadata associated with the paused media program.

23. The media device of claim 22, wherein the system comprises at least one among one or more Internet Protocol Television (IPTV) subsystems, a set-top box (STB), and a media controller that manages operations of the media device.

24. The media device of claim 21, wherein the controller element selects the one or more screensavers according to metadata associated with the paused media program.

25. The media device of claim 21, wherein the media device comprises one among a television set, and a computing device with a display.
